(19) United States
(12) Patent Application Publication
(10) Pub. No.: US 2011/0308092 A1
(43) Pub. Date: Dec. 22, 2011

(54) Slider for a cutter

(75) Inventor: Chun-Peng Lin, Nantou City (TW)

(73) Assignee: SDI Corporation

(21) Appl. No.: 12/803,162

(22) Filed: Jun. 21, 2010

(51) Int. Cl. B26B 3/06

(52) U.S. Cl. 30/164

(57) ABSTRACT

A slider has an upper sliding element, a lower sliding element and a resilient tab. The upper sliding element has two protrusions laterally formed on and protruding from the upper sliding element. Each protrusion has an inclined pushing surface. The lower sliding element is combined with the upper sliding element and has a chamber and two through hole. The through holes are defined in the lower sliding element at positions corresponding respectively to the inclined pushing surfaces of the protrusions and communicate with the chamber. The resilient tab is held in the chamber and has two legs protruding inward from two ends of the resilient tab. Each leg has an engaging end extending out from one of the through holes in the lower sliding element and abutting with the inclined pushing surface of a corresponding one of the protrusions on the upper sliding element.

### BACKGROUND OF THE INVENTION

1. Field of the Invention

The present invention relates to a slider, and more particularly to a slider for a cutter and that can be pushed and moved smoothly.

2. Description of Related Art

To cut papers or the like, a cutter is always widely used and comprises a blade holder, a blade and a slider. The blade is mounted slidably in the blade holder. The slider is mounted slidably on the blade holder and is connected to the blade to push the blade out from the blade holder in different desired lengths to fit with different working needs.

With reference to FIG. 8, Taiwan Utility Model No. M257268, entitled to “Cutter”, discloses a slider comprising an upper sliding element 70, a lower sliding element 72 and a resilient tab 74. The upper sliding element 70 has two pushing posts 702 formed on and protruding from the upper sliding element 70. The lower sliding element 72 is combined with the upper sliding element 70. The resilient tab 74 is mounted between the upper and lower sliding elements 70,72 and has two legs 742 abutting respectively with the pushing posts 702 on the upper sliding element 70. The legs 742 of the resilient tab 74 engage teeth formed in a blade holder to hold a blade that is connected with the slider at position relative to the blade holder.

When the slider is pushed, one of the legs 742 can be pushed by a corresponding pushing post 702 to disengage from the teeth, such that the blade is moved relative to the blade holder to extend out from or retract into the blade holder. Consequently, the legs 742 can automatically engage the teeth with the resilient recoil forces of the legs 742, and the blade with the slider can be positioned relative to the blade holder at a desired position.

However, the pushing posts 702 of the conventional slider are formed as ribs, so the structural strength of the conventional pushing posts 702 is not sufficient. Especially, the pushing posts 702 easily are deformed or do not achieve desired sizes during the mold-injection process of forming the upper sliding element 70.

Additionally, the pushing posts 702 of the conventional slider abut with and push against middle portions of the legs 742 of the resilient tab 74, so a large force for pushing the legs 742 to disengage from the teeth is needed. Thus, a user has to push the slider with a large force, so the operation of the conventional slider is laborious.

With reference to FIG. 9, U.S. Pat. No. 4,794,693, entitled to “Slider For A Cutter Knife” discloses a slider having a release protrusion 80. The release protrusion 80 has two ends abutting respectively with inner surfaces of two connecting flaps of a resilient stopper 82 to make the flaps of the stopper 80 engaging stopper dents defined in a holder. With the engagement between the flaps of the stopper 80 and the dents, the slider with a blade connected thereto can be held at position.

However, because the ends of the release protrusion 80 abut respectively with the inner surfaces of the flaps of the stopper 80, the flaps of the stopper 80 are pushed outward to disengage from the dents. With the outward bend of the flaps, the recoil force provided by the flaps to reengage the dents is small and insufficient. Thus, the engagement between the flaps with the dents may be not completed, so the positioning effect provided to the slider with the blade is not stable. Additionally, a pin 84 is needed for mounting the stopper 82 onto the slider, to assemble the conventional slider is trouble. Furthermore, the '693 Patent also discloses an alternative embodiment comprising two protrusions abutting respectively with outer surfaces of two flaps of a stopper, but to disengage ends of the flaps from dents needs a large force. The operation of the slider of the '693 Patent is also laborious and inconvenient.

To overcome the shortcomings, the present invention tends to provide a slider for a cutter to mitigate or obviate the aforementioned problems.

### SUMMARY OF THE INVENTION

The main objective of the invention is to provide a slider for a cutter and that has a simplified structure with stable components, can be assembled easily and pushed and moved smoothly and is labor-saving in operation. The slider has an upper sliding element, a lower sliding element and a resilient tab. The upper sliding element has an inner side and two protrusions. The protrusions are laterally formed on and protrude from the inner side of the upper sliding element. Each protrusion has an end facing to each other and an inclined pushing surface defined in the end of the protrusion. The lower sliding element is combined with the upper sliding element and has an outer side, an inner side, a blade mount, a chamber and two through hole. The outer side faces the inner side of the upper sliding element, and the inner side is opposite to the inner side of the upper sliding element. The blade mount protrudes from one end of the lower sliding element. The chamber is defined in the lower sliding element and has an opening in the inner side of the lower sliding element. The through holes are defined in the lower sliding element at positions corresponding respectively to the inclined pushing surfaces of the protrusions on the upper sliding element and communicate with the chamber. The resilient tab is held in the chamber in the lower sliding element and has two legs protruding inward from two ends of the resilient tab. Each leg has an engaging end extending out from one of the through holes in the lower sliding element and abutting with the inclined pushing surface of a corresponding one of the protrusions on the upper sliding element.

Other objects, advantages and novel features of the invention will become more apparent from the following detailed description when taken in conjunction with the accompanying drawings.

### BRIEF DESCRIPTION OF THE DRAWINGS

FIG. 1 is a perspective of a cutter with a slider in accordance with the present invention;

FIG. 2 is an exploded perspective view of the cutter with the slider in FIG. 1;

FIG. 3 is an enlarged exploded perspective view of a blade with the cutter in FIG. 1;

FIG. 4 is a side view in partial section of the cutter with the slider in FIG. 1;

FIG. 5 is an enlarged side view in partial section of the slider in FIG. 4;

FIG. 6 is an enlarged operational side view in partial section of the slider in FIG. 4 showing the slider being pushed to extend a blade out from a blade holder;

FIG. 7 is an enlarged operational side view in partial section of the slider in FIG. 4 showing the slider being pushed to retract a blade into a blade holder;

FIG. 8 is an enlarged side view in partial section of a conventional slider shown in Taiwan Utility Model No. M257268; and

FIG. 9 is an enlarged side view in partial section of another conventional slider shown in U.S. Pat. No. 4,794,693.

### DETAILED DESCRIPTION OF PREFERRED EMBODIMENT

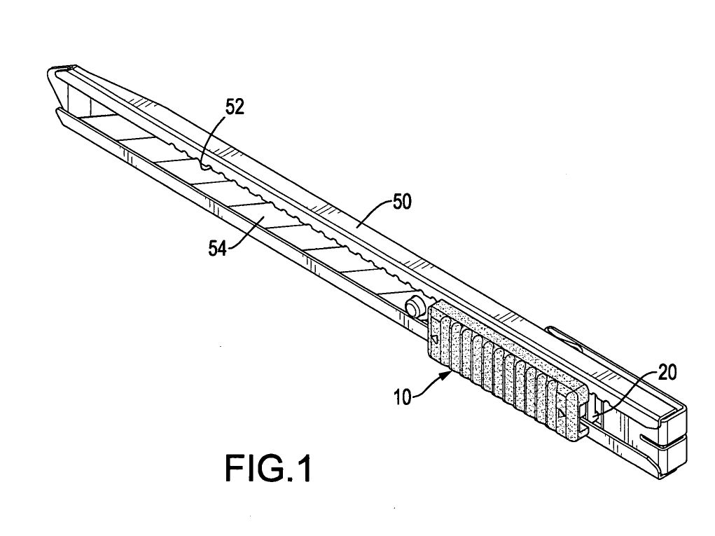

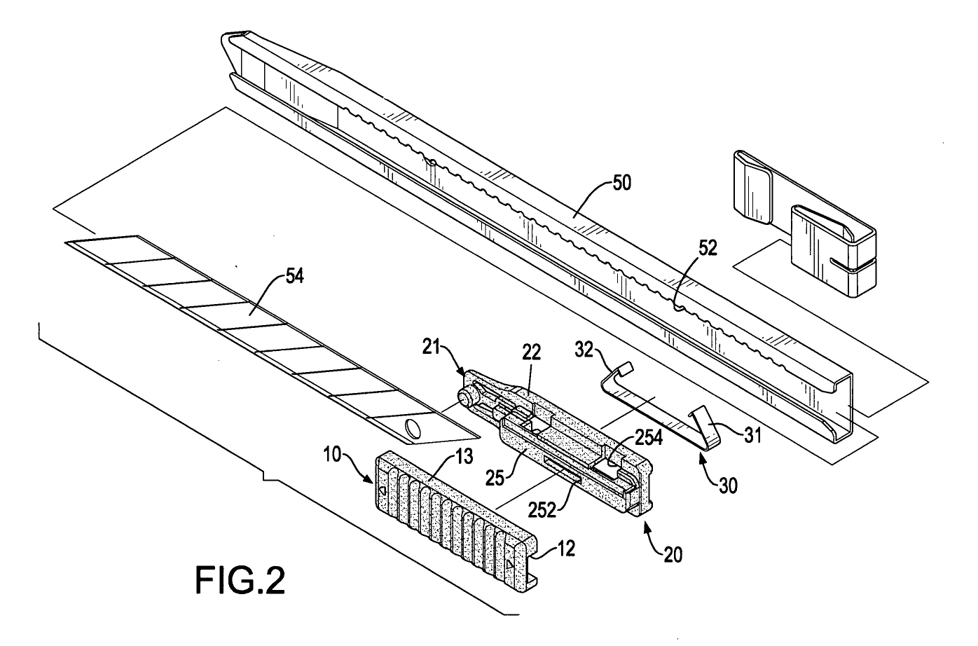

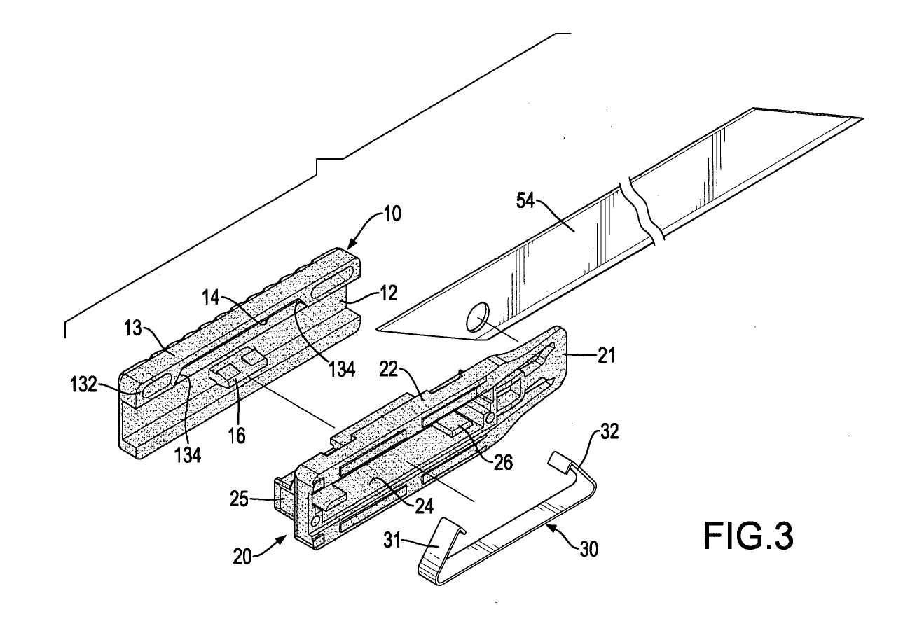

With reference to FIGS. 1 to 3, a slider in accordance with the present invention is mounted slidably on a blade holder 50 of a cutter, is connected to a blade 54 of the cutter to push or pull the blade 54 extending out from or retracting into the blade holder 50 and engages teeth 52 formed on the blade holder 50 to provide a positioning effect to the slider with the blade 54. The slider comprises an upper sliding element 10, a lower sliding element 20 and a resilient tab 30.

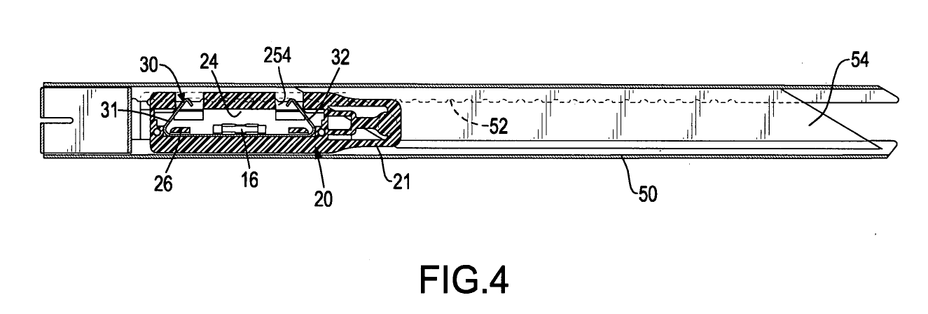

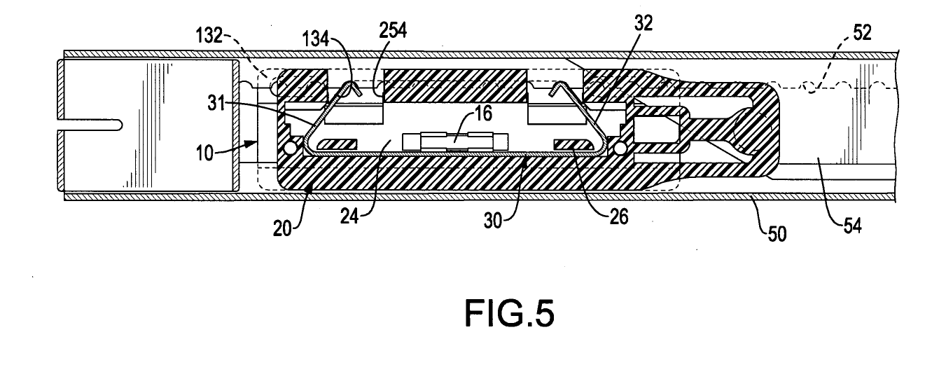

With further reference to FIGS. 4 and 5, the upper sliding element 10 has an inner side, two protrusions 132 and a positioning tab 16.

The protrusions 132 are laterally formed on and protrude from the inner side of the upper sliding element 10. Each protrusion 132 has an end facing to each other and an inclined pushing surface 134 defined in the end of the protrusion 132. Preferably, a holding recess 12 is defined in the inner side of the upper sliding element 10 to define two flanges 13 on the inner side of the upper sliding element 10 respectively on two sides of the holding recess 12. A pushing cutout 14 is defined in a middle portion of one of the flanges 13 to form the protrusions 132 with the inclined pushing surfaces essentially and respectively on two ends of the flange 13. Alternatively, the protrusions 132 can be formed on and protrude directly from the inner side of the upper sliding element 10. The positioning tab 16 is elongated, is laterally formed on and protrudes from a middle portion of a bottom of the holding recess 12.

The lower sliding element 20 is hollow, is combined with the upper sliding element 10, is mounted slidably on the blade holder 50 of the cutter and has an outer side, an inner side, a blade mount 21, two rails 22, a chamber 24, two through holes 254 and two holding tabs 26.

The outer side of the lower sliding element 20 faces the inner side of the upper sliding element 10, and the inner side of the lower sliding element 20 is opposite to the inner side of the upper sliding element 10. The blade mount 21 is formed on and protrudes from one end of the lower sliding element 20 and is connected with the blade 54 of the cutter with a stub. The rails 22 are formed on and protrude from two side edges of the lower sliding element 20 and are respectively mounted slidably in channels defined in the blade holder 50 to mount the lower sliding element 20 slidably on the blade holder 50.

The chamber 24 is defined in the lower sliding element 20 to make the lower sliding element 20 hollow and has an opening defined in the inner side of the lower sliding element 20. The through holes 254 are defined in the lower sliding element 20 at positions corresponding respectively to the inclined pushing surfaces 134 of the protrusions 132 on the upper sliding element 10 and communicate with the chamber 24. Preferably, an extension 25 is formed on and protrudes from the outer side of the lower sliding element 20 and is mounted in the holding recess 12 in the upper sliding element 10, and the through holes 254 are defined through a top of the extension 25. The extension 25 further has an elongated slot 252 defined through the extension 25 and communicates with the chamber 24 in the lower sliding element 20. The positioning tab 16 on the upper sliding element 10 extends into the chamber 24 in the lower sliding element 20 via through the elongate slot 252 in the extension 25. The positioning tab 16 may engage the slot 252 to combine the upper and lower sliding element 10,20 together. A distance is defined between the positioning tab 16 and an inner surface of the chamber 24 of the lower sliding element 20. The holding tabs 26 are formed on and protrude from a bottom of the chamber 24 at an interval. Each holding tab 26 has a distance from the inner surface of the chamber 24 of the lower sliding element 20. The distance between the holding tabs 26 and the inner surface of the chamber 24 is equal to that between the positioning tab 16 on the upper sliding element 10 and the inner surface of the chamber 24.

The resilient tab 30 is held securely in the chamber 24 in the lower sliding element 20 and has a thickness equal to the distance between the positioning tab 16 on the upper sliding element 10/the holding tabs 26 on the lower sliding element 20 and the inner surface of the chamber 24. The resilient tab 30 has two legs 31,32 protruding inward from two ends of the resilient tab 30 and includes a first leg 31 and a second leg 32. Two bent portions are defined at bottom ends of the legs 31,32, and the holding tabs 26 on the lower sliding element 20 abut the resilient tab 30 respectively adjacent to the bent portions. Each leg 31,32 has an engaging end formed opposite to a corresponding bent portion. The engaging end may be curved, extends out from one of the through holes 254 in the lower sliding element 20, are held in the pushing cutout 14, abuts with the inclined pushing surface 134 of a corresponding one of the protrusions 132 on the upper sliding element 10 and engages the teeth 52 on the blade holder 50. Additionally, the inclined pushing surface 134 on the upper sliding element 10 abutting with the engaging end of the first leg 31 is defined as the first inclined pushing surface 134, and the other inclined pushing surface 134 on the upper sliding element 10 abutting with the engaging end of the second leg 32 is defined as the second inclined pushing surface 134.

To combine the slider, the resilient tab 30 is mounted into the chamber 24 of the lower sliding element 20 via the opening and is held between the holding tabs 26 and the inner surface of the chamber 24. With the resilient tab 30 being held between the holding tabs 26 and the inner surface of the chamber 24, the resilient tab 30 is mounted securely in the chamber 24 of the lower sliding element 20. At this time, the engaging ends of the legs 31,32 of the resilient tab 30 extend out from the lower sliding element 20 respectively through the through holes 254. The upper sliding element 10 is then mounted around the extension 25 of the lower sliding element 20 with the holding recess 12, and the positioning tab 16 is mounted through the elongated slot 252 and abuts against the resilient tab 30 to provide a further positioning effect to the resilient tab 30. Consequently, the engaging ends of the legs 31,32 of the resilient tab 30 abut respectively with the inclined pushing surfaces 134 on the protrusions 132. After connecting the blade 54 onto the blade mount 21 on the lower sliding element 20, the slider with the blade 54 are inserted into one end of the blade holder 50 to make the engaging ends of the legs 31,32 of the resilient tab 30 engaging the teeth 52 formed on the blade holder 50. After a plug or a cover being attached to the end of the blade holder 50, the cutter is assembled.

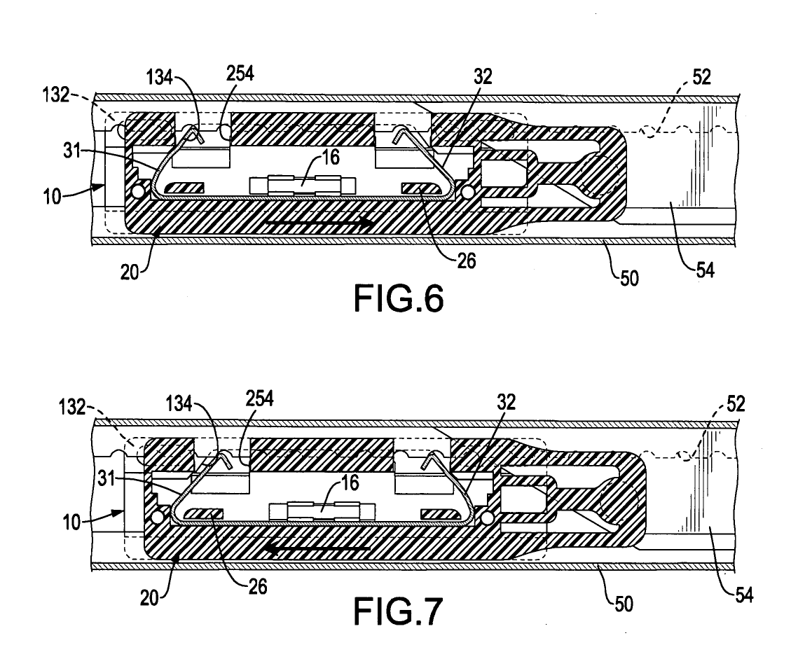

With reference to FIGS. 5 to 7, when the slider is pushed to move relative to the blade holder 50, the blade 54 can be pushed or pulled to extend out from or retract into the blade holder 50. With reference to FIG. 6, when the blade 54 is pushed to extend out from the blade holder 50, the first inclined pushing surface 134 on the upper sliding element 10 will push against the engaging end of the first leg 31 of the resilient tab 30 to disengage from the teeth 52. The curved engaging end of the second leg 32 can be pushed by the teeth 52 to automatically disengage from the teeth 52 during the movement of the slider. During the movement of the slider, the engaging ends of the legs 31,32 of the resilient tab 30 can automatically engage the teeth 52 with the resilient recoil forces provided by the legs 31,32.

When the blade 54 is pushed to extend out from the blade holder 50 in a desired length, the blade 54 can be positioned by the engagement between the engaging ends of the legs 31,32 and the teeth 52 to cut paper or the like.

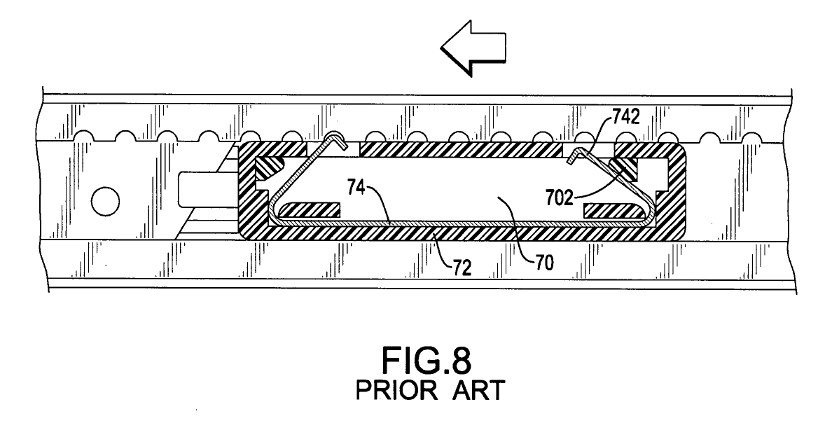

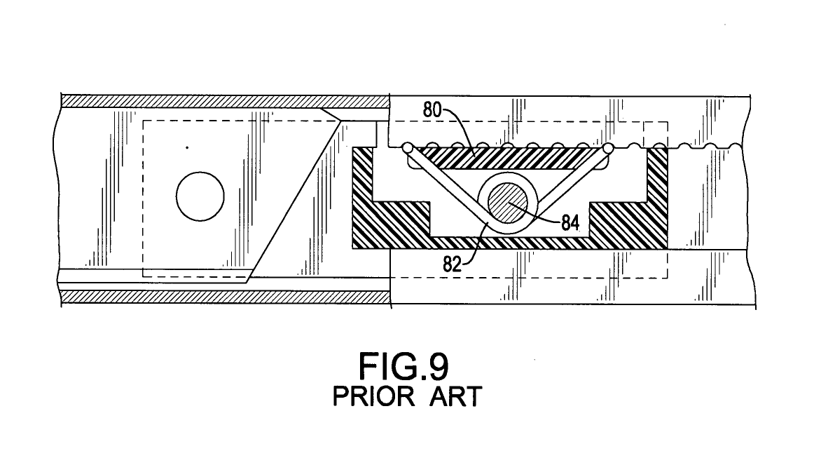

To retract the blade 54 into the blade holder 50, with reference to FIG. 7, the slider is pulled to move in reverse and the second leg 32 of the resilient element 30 is pushed by the second inclined pushing surface 134 on the upper sliding element 10. The engaging end of the second leg 32 can be pushed to disengage from the teeth 52, and the curved engaging end of the first leg 31 can automatically disengage from the teeth 52 in the reverse movement travel of the slider. The resilient recoil forces provided by the legs 31,32 can make the engaging ends automatically engaging the teeth 52 to provide a positioning effect to the slider with the blade 54.

With such an arrangement, the curvature of the engaging ends of the legs 31,32 can be changed to adjust the engagement strength between the engaging ends with the teeth 52 on the blade holder 50 for fitting with different design or use needs. Sounds can occur by the engaging ends bumping with the teeth 52 during the movement of the slider.

Additionally, the resilient tab 30 can be inherently held in place during the process of the combining the upper and lower sliding elements 10,20, to assemble the slider is easy and convenient. Moreover, the protrusions 132 laterally formed on the upper sliding element 10 provide an improved structural strength and a sufficient pushing force to the legs 31,32 of the resilient tab 30 and is not easily damaged or broken. The lateral extending protrusions 132 are not easily deformed or can easily achieve desired sizes during the mold-injection process, the structure of the protrusions 132 is stable and durable.

Furthermore, with the inclined pushing surfaces 134 abutting with outer sides of the engaging ends of the legs 31,32 of the resilient tab 30, the legs 31,32 are pushed to bend inward relative to each other. The movement and bend of the legs 31,32 can be limited in the range defined by the pushing recess 14 in the upper sliding element 10, so the recoil movement of the legs 31,32 to engage the teeth 52 is precisely and actually. A small force is needed to push the slider to move and to bend the legs 31,32, but a large recoil force is provided by the legs 31,32 to reengage the engaging ends with the teeth 52. Therefore, the slider is easily pushed and the movement of the slider is smooth, and the engaging ends of the resilient tab 30 can be kept from being jammed.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A slider for a cutter comprising:
an upper sliding element having
an inner side; and
two protrusions laterally formed on and protruding from the inner side of the upper sliding element, and each protrusion having an end facing to each other and an inclined pushing surface defined in the end of the protrusion;
a lower sliding element combined with the upper sliding element and having
an outer side facing the inner side of the upper sliding element;
an inner side opposite to the inner side of the upper sliding element;
a blade mount protruding from one end of the lower sliding element;
a chamber defined in the lower sliding element and having an opening in the inner side of the lower sliding element; and
two through holes defined in the lower sliding element at positions corresponding respectively to the inclined pushing surfaces of the protrusions on the upper sliding element and communicating with the chamber; and
a resilient tab held in the chamber in the lower sliding element and having
two legs protruding inward from two ends of the resilient tab and each having an engaging end extending out from one of the through holes in the lower sliding element and abutting with the inclined pushing surface of a corresponding one of the protrusions on the upper sliding element.

2. The slider as claimed in claim 1, wherein
the upper sliding element further has
a holding recess defined in the inner side of the upper sliding element to define two flanges on the inner side of the upper sliding element respectively on two sides of the holding recess; and
a pushing cutout defined in one of the flanges to make the protrusions with the inclined pushing surfaces essentially formed respectively on two ends of the flange in which the pushing cutout is defined.

3. The slider as claimed in claim 2, wherein
the lower sliding element further has an extension formed on and protruding from the outer side of the lower sliding element and mounted in the holding recess in the upper sliding element; and
the through holes in the lower sliding element are defined through a top of the extension.

4. The slider as claimed in claim 3, wherein
the extension of the lower sliding element has an elongated slot defined through the extension and communicating with the chamber in the lower sliding element; and
the upper sliding element further has a positioning tab formed on and protruding from a bottom of the holding recess, mounted through the elongate slot in the extension on the lower sliding element and extending into the chamber in the lower sliding element.

5. The slider as claimed in claim 4, wherein the positioning tab on the upper sliding element has a distance from an inner surface of the chamber of the lower sliding element and equal to a thickness of the resilient tab.

6. The slider as claimed in claim 5, wherein the lower sliding element further has two holding tabs formed on and protruding from a bottom of the chamber at an interval.

7. The slider as claimed in claim 6, wherein each holding tab has a distance from the inner surface of the chamber of the lower sliding element and equal to the thickness of the resilient tab.

8. The slider as claimed in claim 7, wherein the engaging end of each leg of the resilient tab is curved.

9. The slider as claimed in claim 8, wherein the lower sliding element further has two rails formed on and protruding from two side edges of the lower sliding element.

10. The slider as claimed in claim 9, wherein the slider is adapted to mount slidably on a blade holder and the engaging ends of the legs of the resilient tab are adapted to engage teeth defined in the blade holder.

11. The slider as claimed in claim 1, wherein the lower sliding element further has two holding tabs formed on and protruding from a bottom of the chamber at an interval.

12. The slider as claimed in claim 11, wherein each holding tab has a distance from the inner surface of the chamber of the lower sliding element and equal to the thickness of the resilient tab.

13. The slider as claimed in claim 12, wherein the engaging end of each leg of the resilient tab is curved.

14. The slider as claimed in claim 13, wherein the lower sliding element further has two rails formed on and protruding from two side edges of the lower sliding element.

15. The slider as claimed in claim 14, wherein the slider is adapted to mount slidably on a blade holder and the engaging ends of the legs of the resilient tab are adapted to engage teeth defined in the blade holder.

16. The slider as claimed in claim 1, wherein the engaging end of each leg of the resilient tab is curved.

17. The slider as claimed in claim 1, wherein the lower sliding element further has two rails formed on and protruding from two side edges of the lower sliding element.

18. The slider as claimed in claim 1, wherein the slider is adapted to mount slidably on a blade holder and the engaging ends of the legs of the resilient tab are adapted to engage teeth defined in the blade holder.
